(19) United States
(12) Patent Application Publication
(10) Pub. No.: US 2010/0198696 A1
(43) Pub. Date: Aug. 5, 2010

(54) Methods and Systems for Creating Interactive Advertisements

(76) Inventor: Ashish Suresh Deshpande, Guilford, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/532,265

(22) PCT Filed: Mar. 20, 2008
(86) PCT No.: PCT/US08/57666

§ 371 Date: Apr. 1, 2010

Related U.S. Application Data
(60) Provisional application No. 60/896,085, filed on Mar. 21, 2007.

(51) Int. Cl. G06F 3/01; G06Q 30/00; G06F 17/00

(52) U.S. Cl. 705/14.72; 715/760; 715/234

(57) ABSTRACT

Methods and systems for creating an interactive advertisement in a web browser environment are disclosed. The method includes the following: choosing a template for the advertisement from a set of standard templates; uploading an image or video file in one of several formats or customizing text content of the advertisement; customizing information collection panes in the advertisement; customizing a thank you message; and specifying an action that the advertisement should take upon completion. The system includes the following modules: a template module including standard templates based on industry-standard ad sizes; an upload module for uploading an image or video file in one of several formats; a text module for customizing text content of the advertisement; a layout module for customizing information collection panes; a thank you module for customizing a thank you message; and an action module for specifying an action that the advertisement should take upon completion.

### BACKGROUND

(1) Field

The present application generally relates to methods and systems for creating interactive advertisements.

(2) Description of the Related Art

The various formats of online advertisements are based on their relationship to content (content-adjacent such as banner or rectangle advertisements or content independent such as pop-up advertisements) and their functionality (static text or interactive). According to Forrester, medium/large rectangular advertisement formats with interactive functionality are most effective and generate higher awareness. Interactive advertisements increase their return because they require a consumer to get actively involved in a promotion.

Today, online advertisements in any category or format are not truly interactive—clicking on one of these advertisements opens a new window that overlays the existing content and takes the user to the marketer's web site. This approach is very obtrusive, is often annoying to consumers, and is completely unacceptable in situations such as on-demand television via the Internet, mobile phones, and online games.

Today's interactive advertisements allow users to navigate through informational tabs or play a simple game. They display marketing messages or entertain the consumer but fail to take advantage of the fact that the Internet offers two-way communication between the marketer and the consumer. In reality, they are nothing more than television-style commercials running in a section of the browser window. The only way the consumer can interact with the marketer is by clicking through to the marketer's web site, typically in a separate overlaid window.

One of the main reasons for this lack of two-way interactive functionality is the cost and difficulty of creating this kind of advertisement. Ordinary users (non-programmers) simply cannot create advertisements that collect an email address or telephone number from consumers without forcing them to leave the existing content and visit an application on the marketer's site. For example, a click on the “Apply Now” button commonly found on credit card advertisements opens a new browser window overlaying the original content that contains a large form that must be filled in. Most users, particularly those interacting with social networking sites, watching a television episode on the Internet, or playing online games are just not likely to fill out these lengthy forms and will be extremely annoyed if their original content is blocked out. The advertisement is not a proactive sales/lead generation tool.

In summary, today's Internet advertisements dominate the screen by overlaying the original content with marketing content. They are passive in that they display marketing information but do not collect information from the user. There is no way for the user to interact with the marketer just through the advertisement. He/she is forced to visit a separate web page. They are either very simple text-based advertisements that are created by the user (for example the advertisements with a Header, two-line description and link that are found on Google or Yahoo's search pages) or, if they have rich media content, they must be created by professional programmers and/or graphic artists. There is no way for a regular user to create an advertisement, which has rich-media, multiple panels, and information collection widgets and which can deliver the information to the marketer without significant programming.

### BRIEF SUMMARY

A method for creating an interactive advertisement in a web browser environment is disclosed. Some embodiments of the method include the following: choosing a template for the advertisement from a set of standard templates based on industry-standard ad sizes; uploading an image or video file in one of several formats or otherwise customizing the text content of the advertisement; customizing information collection panes in the advertisement; customizing a thank you message; and specifying an action that the advertisement should take upon completion.

A system for designing an interactive advertisement in a web browser environment is disclosed. Some embodiments of the system include the following modules: a template module including a set of standard templates based on industry-standard ad sizes; an upload module for uploading an image or video file in one of several formats; a text module for customizing text content of the advertisement; a layout module for customizing information collection panes in the advertisement; a thank you module for customizing a thank you message; and an action module for specifying an action that the advertisement should take upon completion.

A method for creating an interactive advertisement is disclosed. Some embodiments of the method include the following: creating a first HTML page for choosing a template for the advertisement from a set of standard templates based on industry-standard ad sizes, the template defining an advertisement that is two-way interactive; creating a second HTML page for uploading an image or video file in one of several formats or customizing text content of the advertisement; creating a third HTML page for customizing information collection panes in the advertisement; creating a fourth HTML page for customizing a thank you message; and creating a fifth HTML page for specifying an action that the advertisement should take upon completion.

### BRIEF DESCRIPTION OF THE DRAWINGS

For the purpose of illustrating the invention, the drawings show a form of the invention that is presently preferred. However, it should be understood that the present invention is not limited to the precise arrangements and instrumentalities shown in the drawings, wherein:

FIG. 1 is a flow diagram of a process for creating an advertisement according to one embodiment of the disclosed subject matter; and

FIG. 2 is a flow diagram of the steps that occur when a user views an advertisement created according to one embodiment of the disclosed subject matter.

### DETAILED DESCRIPTION

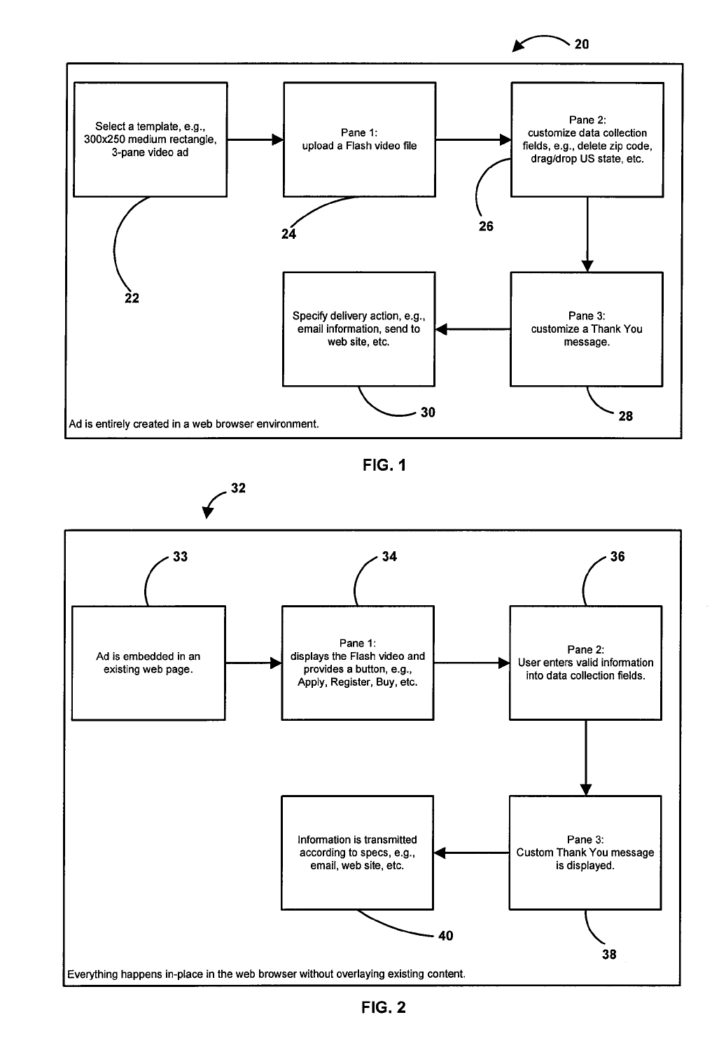

Referring now to the drawings in which like reference numerals indicate like parts, and in particular, to FIG. 1, one aspect of the present application is a method and system 20 for creating an interactive advertisement in a web browser environment. At 22 in FIG. 1, method 20 first includes choosing a template for the advertisement from a set of standard templates based on industry-standard advertisement sizes. One aspect of the system is a module including pre-created templates for many ad sizes and content combinations. An example template includes a template for a medium rectangular ad (300×250) with a Flash video, a form to collect a zip code, email address and optional phone number, and a Thank You message. At 24, the next step in method 20 is uploading an image or video file in one of several formats or otherwise customizing the content of the advertisement. This step depends on the template chosen for the ad. For example, the user might be expected to upload a Flash video. At 26, an additional step is customizing information collection panes in the advertisement. Although not illustrated, in alternative embodiments of the disclosed subject matter, there can be multiple steps at 26, e.g., 26a, 26b, 26c, etc. For example, a user might drag and drop a US State drop down field, delete the phone, or make the zip code optional. Then, at 28, an additional step is customizing a thank you message. At 30, yet another step of method 20 is specifying an action that the advertisement should take upon completion. For example, such actions include emailing the collected information to a specified address or forwarding it to a particular web site. As will be appreciated by one of skill in the art, in addition to the inclusion of multiple steps at step 26, method and system 20 may include greater or fewer process steps. For example, thank you message at 28 may be replaced by, supplemented with the process step of “forward to a URL,” or omitted altogether. The exact process steps required to generate the advertisement will be tailored according to the specific application. In one embodiment, Live Forms Designer by frevvo is used to implement the method and system of the disclosed subject matter.

Alternatively, the method and system of the disclosed subject matter can be implemented by a programmer skilled in the art without the use of an off-the-shelf package such as Live Forms Designer by frevvo. One example implementation includes the following steps: (1) Create a web-based application using any standard web framework, for example, Java/Tomcat/JSP; (2) Create an HTML page (Page 0) that lists the available templates and their characteristics. The information could come from a standard off-the-shelf database. Program a mechanism for selecting one template using, for example, a set of radio buttons. Add a Next button that links to the next page (Page 1); (3) Create an HTML page (Page 1) that allows the user to upload an image or video. This could use a standard HTML form with an Upload control. Program a mechanism on the back end for saving the uploaded image/video, say in a database. Add a Next button that links to the next page (Page 2); (4) Create an HTML page (Page 2) that allows the user to add data collection fields. This could be programmed via a standard HTML form, for example, by allowing a fixed set of fields (email, phone, name . . . ) from which the user can select. Program a mechanism on the server for saving the set of fields added by the user. Add a Next button that links to the next page (Page 3); (5) Create an HTML page (Page 3) that allows the user to add a customized Thank You message. Again, this could be programmed via a standard HTML form in which the user could enter the desired message. Program a mechanism on the server for saving the message added by the user. Add a Next button that links to the next page (Page 4); (6) Create an HTML page (Page 4) that allows the user to specify a delivery action. Again, this could be programmed via a standard HTML form in which the user could select the desired action and specify any auxiliary information. For example, if the selected action were email, the user would need to specify an email address. Add a Next button that links to the next page (Page 5); (7) Create an HTML page (Page 5) that displays Summary information of the new ad to the user and has a Finish button to save the ad; and (7) In addition to the above creation mechanism, the programmer would have to create the databases, server-side scripts and other supporting server programs to serve the ad as an HTML page in an iframe.

If implemented by a programmer and without the use of an off-the-shelf package such as Live Forms Designer by frevvo, the programmer would have to create browser-specific enhancements, which provide a pleasing experience to the viewer of the advertisement. First the advertisement should display the image or play the video (the content uploaded in Page 1 above), then provide a mechanism by which the user can click on the image/video and display the contents of Page 2 above (the data collection fields). This could be programmed using techniques such as standard JavaScript and the data collection fields displayed as a standard HTML form. The field data would need to be validated by the advertisement or the server to ensure that it contains accurate information that meets the specifications of the field and is useful to the advertiser. This could be programmed using techniques such as JavaScript on the browser and/or Java/JSP on the server. When the field data is filled out and the user clicks the Submit button, the information is transmitted to the server. The programmer must save this information and perform the delivery action specified in Page 4. This could entail programming code to send an email or transmit the data to a web server, etc., as well as additional programming code to format the data in a manner consistent with the advertiser's requirements. Finally, the contents of Page 3 (Thank you message) should be displayed in response to the data submission. This can be done using standard web server techniques.

In at least one embodiment, the advertisement is two-way interactive. It can display information to the consumer in a variety of formats—from text to video—similar to a TV commercial or a print advertisement and it can also collect information from the user, for example a zip code and an email address and a phone number. The advertisement automatically validates this information in-place in order to ensure that the collected information is legitimate and useful to the marketer. Upon collection of this information, the advertisement can deliver the information in a coherent manner to the marketer—for example, via an email message or to a specified web site.

The advertisement generally consists of multiple views/panels that change in-place. For example, consumers can view a video in one pane and enter information in a second pane without leaving the web page that they are viewing in which the advertisement is embedded. Two-way interaction with the advertisement takes place without overlaying the original web page with the marketer's web page and without disrupting the user's online experience.

The advertisement is capable of displaying rich-media (images and video) as well as standard text content. The advertisement (including the rich media content, multiple panes, and information collection widgets) are typically created in a standard, modern web browser in a self-service manner. Creators do not need to install any special software (other than software required to create images or videos to embed in one of the panes of the advertisement) or write any programming code for the explicit purpose of creating the advertisement. The advertisement is typically a web (HTML) form created using technology such as frevvo's Live Forms or similar. Regular, non-technical users can create rich ads with multiple panels and information collection widgets using a wizard-like interface and without significant programming.

The advertisement is typically but not necessarily live, i.e., the advertisement is connected to a server, e.g., a frevvo Live Ads server. When the consumer enters a value in an information collection field, that value is immediately transmitted to the server for validation, to apply any business rules, display further relevant information to the consumer etc. For example, the advertisement may ask for a zip code. When the consumer enters a zip code, the advertisement communicates it to the server, which checks for availability of the specific item of interest in stores within 5 miles of the indicated zip code and displays that information in the advertisement. The advertisements can collect any amount of information in-place using any number of panes.

The technology, e.g., Live Ads, supports the exact same technologies and mechanisms used today—for example, the advertisement is displayed in an HTML iframe on the publisher's site and the content for the iframe is delivered from one or more servers, e.g., frevvo Live Ads servers or third-party servers hosting technology for creating ads.

When the advertisement is displayed on a content publisher's site, it is essentially an embedded live form displayed in a section of the publisher's site. The advertisement will typically display the first pane containing a video, image, or text content and a mechanism (typically a web button) that enables the consumer to express interest in the marketer's product—for example, ‘Click Here to Apply’ or ‘Check Availability’ or ‘Buy Now’.

If the consumer clicks on the button, the advertisement will display a succession of one or more panes in-place without overlaying the original web page and the consumer can enter relevant information in the same area of the screen. As the consumer enters information in the information collection fields, it is automatically validated. If there is an error—for example, an invalid zip code is entered, e.g., it has letters, the consumer is immediately warned via some visible mechanism—for example, the field's background might turn red.

The advertisement provides the consumer with the ability to navigate Forward or Backward through the panes. Typically, this is in the form of web buttons. When the necessary information has been collected and validated, the advertisement will then deliver the collected information (e.g., via a server such as a frevvo Live Ads server) to the marketer—for example, via a web site or email address.

Referring now to FIG. 2, one embodiment 32 of the disclosed subject matter is illustrated in an example of an advertisement including a discount coupon for an auto purchase. In this example, an auto manufacturer, e.g., Ford creates an Internet ad that includes three panes, which is embedded in a web page at 33. At 34, in the first pane, the consumer sees a video about a new Ford model that is now in showrooms. This is similar to a television commercial. The consumer is then offered a $500 discount coupon if he purchases the car—in order to receive the coupon the consumer must click on a button displayed in the pane. At 36, when the consumer clicks the button in pane 1, he is brought to the second pane. In this pane, the consumer must enter a valid zip code and email address and optionally a phone number. The information cannot be transmitted unless the zip code and email address are valid. At that point, the consumer can click a button called ‘Finish’ or ‘Receive Coupon’. At 38, the consumer is brought to the third pane, which simply displays a Thank You message and informs him that the discount coupon is being sent to the email address that was registered on the previous page. At the same time or after the Thank You message is displayed, at 40, information is transmitted according to specs, e.g., email, web site, etc.

There are myriad examples of applications of the subject matter disclosed in the present application:

Register for a promotion. Apple is releasing a new highly anticipated phone. Register here (enter an email address and phone number) to get in line for your phone.

Apply for a credit card. Chase displays an ad touting the benefits of its platinum card. Enter an email address in the next pane and an application form is sent to you via email.

Check ski slope conditions. Mt. Okemo displays an ad claiming fantastic ski conditions. Click on the Check Now button and the current conditions (number of open lifts, snow depth etc.) are displayed. Click again, enter an email address and a 2-for-1 coupon is sent to the email address.

Buy a book. The user is reading an article about the latest Harry Potter book and the expected frenzy to obtain a copy. Barnes & Noble displays an ad guaranteeing delivery by 10 AM the day the book is released and a ‘Buy Now’ button. If the consumer clicks on the button, the next pane allows the user to buy in-place by either entering a credit card number or using services such as Google Checkout.

Another embodiment includes a system for designing an interactive advertisement in a web browser environment. The system includes the following modules: a template module including a set of standard templates based on industry-standard ad sizes; an upload module for uploading an image or video file in one of several formats; a text module for customizing text content of the advertisement; a layout module for customizing information collection panes in the advertisement; a thank you module for customizing a thank you message; and an action module for specifying an action that the advertisement should take upon completion.

Although the invention has been described and illustrated with respect to exemplary embodiments thereof, it should be understood by those skilled in the art that the foregoing and various other changes, omissions and additions may be made therein and thereto, without parting from the spirit and scope of the present invention. Accordingly, other embodiments are within the scope of the following claims.

What is claimed is:

1. A method for creating an interactive advertisement, said method comprising:
choosing a template for the advertisement from a set of standard templates based on industry-standard ad sizes, said template defining an advertisement that is two-way interactive;
uploading an image or video file in one of several formats or customizing text content of the advertisement;
customizing information collection panes in the advertisement;
customizing a thank you message; and
specifying an action that the advertisement should take upon completion.

2. A method according to claim 1, said template defining an advertisement that does not overlay an original web page.

3. A method according to claim 1, wherein the advertisement consists of multiple panels that are adapted to change in-place.

4. A method according to claim 1, wherein the advertisements are created in a standard, modern web browser.

5. A method according to claim 1, wherein the advertisement is a hypertext markup language form.

6. A method according to claim 1, wherein the advertisement is live.

7. A method according to claim 1, wherein the advertisement is capable of displaying both rich-media and standard text content.

8. A method according to claim 1, wherein the ads can collect any amount of information in-place.

9. A method according to claim 1, further comprising creating a plurality of interconnected hypertext markup language forms.

10. A system for designing an interactive advertisement in a web browser environment, said system comprising:
a template module including a set of standard templates based on industry-standard ad sizes;
an upload module for uploading an image or video file in one of several formats;
a text module for customizing text content of the advertisement;
a layout module for customizing information collection panes in the advertisement;
a thank you module for customizing a thank you message; and
an action module for specifying an action that the advertisement should take upon completion.

11. A method for creating an interactive advertisement, said method comprising:
creating a first HTML page for choosing a template for the advertisement from a set of standard templates based on industry-standard ad sizes, said template defining an advertisement that is two-way interactive;
creating a second HTML page for uploading an image or video file in one of several formats or customizing text content of the advertisement;
creating a third HTML page for customizing information collection panes in the advertisement;
creating a fourth HTML page for customizing a thank you message; and
creating a fifth HTML page for specifying an action that the advertisement should take upon completion.

12. A method according to claim 11, said template defining an advertisement that does not overlay an original web page.

13. A method according to claim 11, wherein the advertisement consists of multiple panels that are adapted to change in-place.

14. A method according to claim 11, wherein the advertisements are created in a standard, modern web browser.

15. A method according to claim 11, wherein the advertisement is a hypertext markup language form.

16. A method according to claim 11, wherein the advertisement is live.

17. A method according to claim 11, wherein the advertisement is capable of displaying both rich-media and standard text content.

18. A method according to claim 11, wherein the ads can collect any amount of information in-place.

19. A method according to claim 11, further comprising creating a plurality of interconnected hypertext markup language forms.
